(19) United States
(12) Patent Application Publication
(10) Pub. No.: US 2011/0160994 A1
(43) Pub. Date: Jun. 30, 2011

(54) AUTO-DETECTION OF A FIELD IN FLEET MANAGEMENT

(75) Inventors: LEE A. SCHMIDT, NEWTON, KS (US); LORENZ RIEGGER, RIEDHAUSEN, DE (US); CHRISTOPHER BURTON O'NEIL, WICHITA, KS (US)

(73) Assignee: AGCO CORPORATION, Duluth, GA (US)

(21) Appl. No.: 12/648,985

(22) Filed: Dec. 29, 2009

(51) Int. Cl. G01C 21/00; G06F 17/30

(52) U.S. Cl. 701/200; 707/740; 707/E17.018; 707/705

(57) ABSTRACT

A field boundary may be provided. First, a plurality of location data points may be received. Next, it may be determined whether each of the plurality of location data points is associated with at least one work area. Then a boundary line of the at least one work area may be identified from at least a subset of the plurality of location data points.

### BACKGROUND

Auto-detection of a field in fleet management is a process for determining the location of a field from collected GPS data. In some situations, a work area, such as an agricultural field, can be difficult to accurately define. An accurate border may be necessary, however, to properly and efficiently deploy equipment for working the field. For example, a user may have to manually draw and adjust borders in a software application, such as Computer Aided Design (CAD) software. This often causes problems because it may be extremely time consuming and prone to user error.

### SUMMARY

A field boundary may be provided. First, a plurality of location data points may be received. Next, it may be determined whether each of the plurality of location data points is associated with at least one work area. Then a boundary line of the at least one work area may be identified from at least a subset of the plurality of location data points.

Both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a block diagram of an apparatus for generating a data point;

FIG. 3 is a flow chart of a method for identifying a field boundary;

FIG. 4 is a flow chart of a subroutine for analyzing the data points;

FIG. 5 is a diagram illustrating collected data points; and

FIG. 6 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Automatic detection of a field may be provided. Consistent with embodiments of the present invention, a machine may be equipped with a Global Positioning System (GPS) and an onboard computing device. The machine may log its position on a periodic basis, such as every ten seconds. This position data may be coupled with other data, such as a timestamp, a machine identifier, a work state (e.g., working, paused, unloading, or traveling), a fuel level, remaining grain tank volume, crop yields, and/or machine speed. These data points may be collected from multiple machines over a period of time and analyzed in batches. For example, the data points collected by irrigation trucks, sprayers, harvesters, tillers, etc. over the course of a month may be collected and analyzed together.

The analysis of these data points may allow the identification of field boundaries. Once identified, the field boundaries may be used to produce reports, plan future usage, and plot waylines for the use of machines working in the identified fields. For example, by grouping data points by time and type of work done, it may be possible to identify a boundary between two fields, such as where one line of data points is associated with irrigation while an adjacent line of data points collected on the same day is associated with harvesting. Similarly, data points collected by machines performing the same function (e.g., harvesting) but logging different crop yields may indicate different fields. Known topographical features, such as rivers, roads, and/or buildings may also provide guidance for establishing a border.

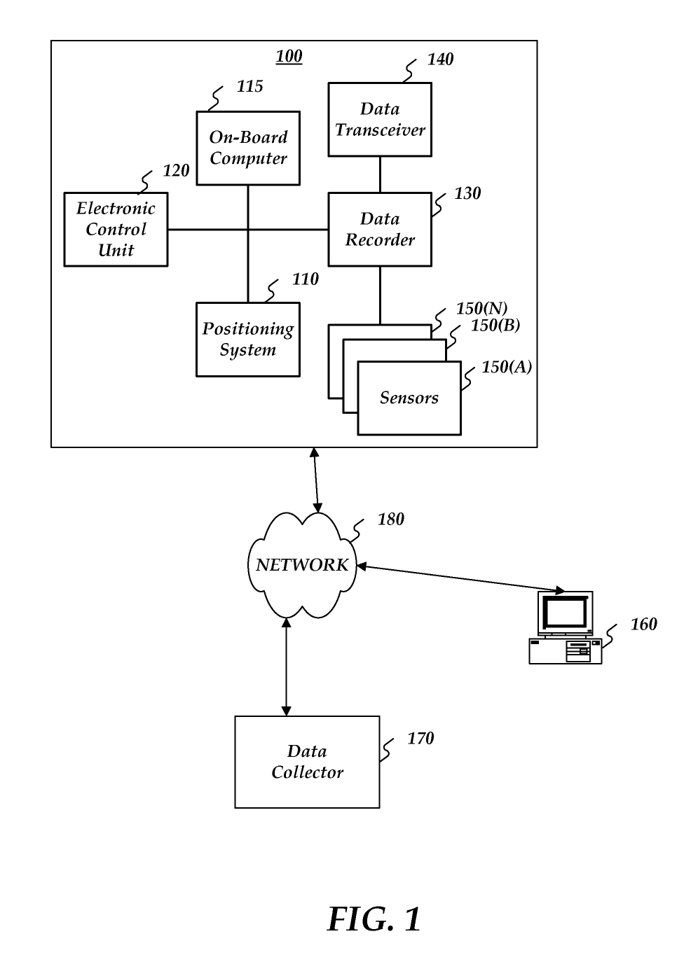

FIG. 1 is a block diagram of an operating environment 100. Operating environment 100 may comprise a positioning system 110, an electronic control unit 120, a data recorder 130, and a data transceiver 140. Data recorder 130 may be coupled to a plurality of sensors 150(A)-150(N). Positioning system 110 may comprise, for example, a GPS system. Electronic control unit 120 may comprise an autosteer system operative to control various aspects of an apparatus' functionality, such as speed, direction, and work state. An example of such an autosteer system may comprise the Auto-Guide™ system produced and distributed by AGCO® of Duluth, Ga.

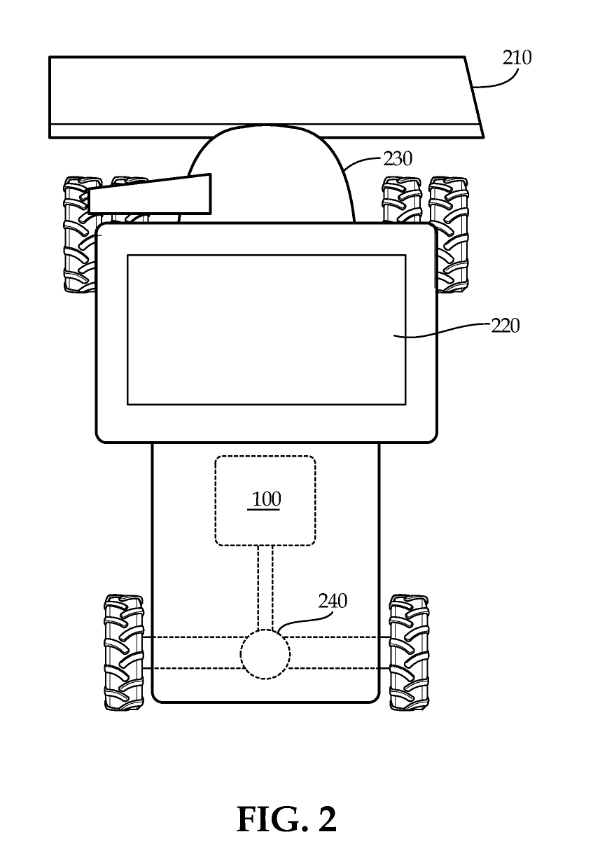

FIG. 2 is a block diagram of an apparatus 200 for generating a data point. Apparatus 200 may comprise, for example, a harvester comprising a work implement 210, a harvested material bin 220, and an operator cab 230. Apparatus 200 may further comprise a drive system 240 comprising an engine and a steering linkage (not shown) coupled to the components of operating environment 100. Further details regarding the components of a combine harvester are disclosed in U.S. Pat. No. 5,873,227, which is hereby incorporated by reference in its entirety. Data recorder 130 may be operative to record data points associated with apparatus 200 at various intervals based on factors such as speed, orientation, time, and/or work performed. For example, data recorder 130 may create a data point every minute recording a current speed and direction, whether or not work implement 210 is active, a crop yield for the area covered, a current level of harvested material bin 220, and an estimated time until harvested material bin 220 may be full. Consistent with embodiments of the invention, data recorder 130 may be operative to record data points more often when apparatus 200 is moving along a curve than when moving in a straight line in order to more accurately reflect the path followed.

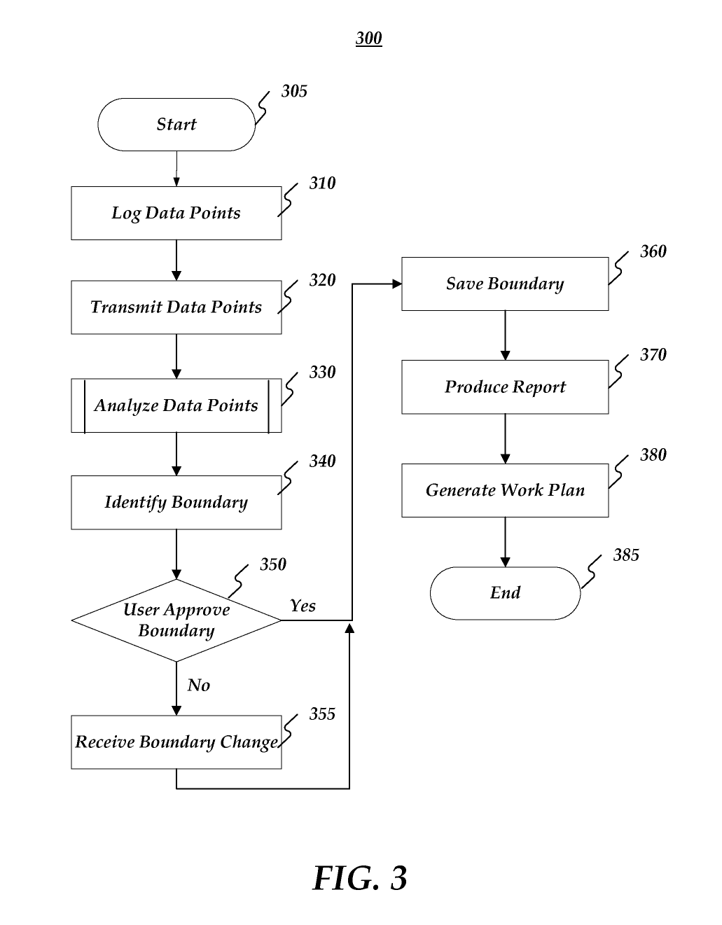

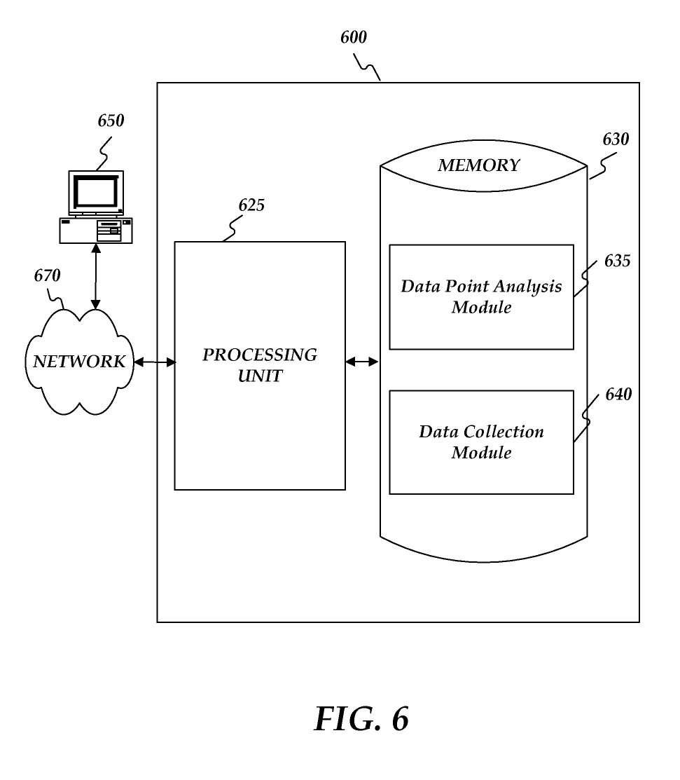

FIG. 3 is a flow chart setting forth the general stages involved in a method 300 consistent with an embodiment of the invention for providing auto-detection of a field boundary. Method 300 may be implemented using apparatus 200 and/or a computing device 600 as described in more detail below with respect to FIG. 6. Ways to implement the stages of method 300 will be described in greater detail below.

Method 300 may begin at starting block 305 and proceed to stage 310 where apparatus 200 may log a plurality of data points. For example, apparatus 200 may create a data point every 10 seconds, capturing information such as current location, speed, and direction. Other information may comprise identifying data such as an operator name and/or machine identifier, work state (e.g., idle, active, or traveling), and/or fuel usage. Apparatus 200 may also be operative to log data associated with the work being done, such as crop yields and quality and/or consumable usage (e.g., amount and type of herbicide, pesticide, seeds, and/or irrigation water used in the work area).

Once the data points have been logged at stage 310, method 300 may advance to stage 320 where apparatus 200 may transmit the logged data points to a central system. For example, each of a plurality of apparatuses may transmit their data points to a field management system, such as the GTA Software Suite produced and distributed by AGCO® of Duluth, Ga.

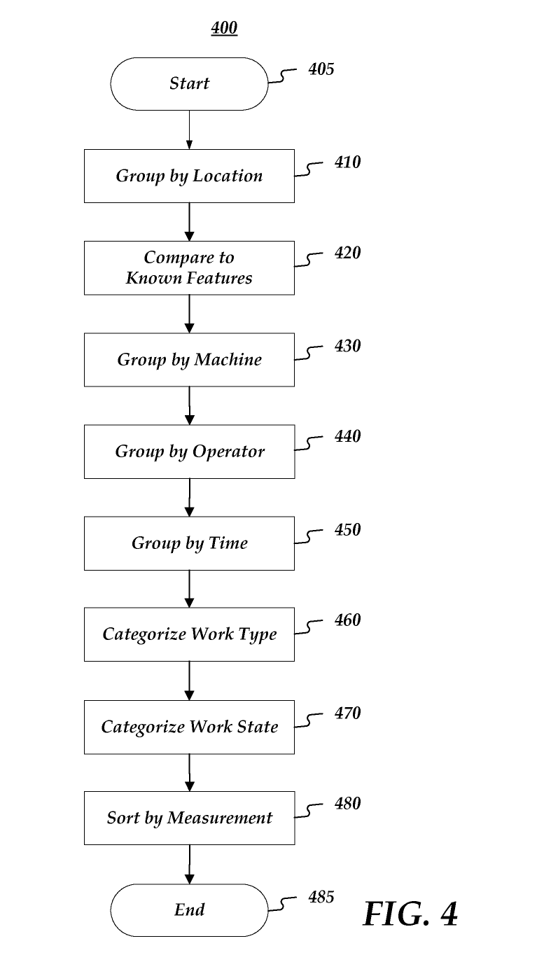

After transmitting the data points at stage 320, method 300 may advance to subroutine 330 where computing device 600 may analyze the collected database. For example, the field management system may execute the stages of a method 400 for analyzing the data points as described below with respect to FIG. 4. Consistent with embodiments of the invention, computing device 600 may also comprise an on-board computer of apparatus 200.

After analyzing the data points in subroutine 330, method 300 may advance to stage 340 where computing device 600 may identify a boundary of a work area. For example, the field management system may use the analyzed data points to project a tentative boundary for a work area, such as a field. The analysis may result groupings of data points and/or partial boundaries that may help identify a work area around which a boundary may be drawn. Data points within a threshold distance of each other and/or gathered within a threshold time span may be grouped into a tentative field boundary.

Additional attributes, such as natural boundaries (e.g., rivers) or other distortions (e.g., drainage areas, sudden elevation changes or terraces, roads, or buildings) may be taken into account and excluded from the field area within the boundary. These thresholds may be adjusted according to known factors, such as field separation distances. For example, fields in Europe tend to have less separation between them than fields in the United States. Therefore, when applied to field data in Europe, the threshold distance between data points to be associated as a single field may be shorter than in the U.S. For another example, an area where GPS reception is poor may have a larger threshold distance in order to correct for missing data points.

Consistent with embodiments of the invention, attributes associated with the geographic area may be applied to adjust the identified boundary. Such attributes may comprise GPS sensitivity, including known areas of poor reception that may result in missing data points. For example, a particular ten square meter area may not be associated with any data points, but be surrounded by worked data points that are associated with a single field. If the area is known to experience poor GPS reception, the field boundary may be expanded to encompass the area. On the other hand, if the area is known to comprise a drainage area, the field boundary may be adjusted to exclude the area from the field.

Stage 340 may comprise an iterative stage of method 300 operative to identify a plurality of field boundaries from a data set and/or refine a tentative field boundary. For example, the data points may be associated with a large geographic area comprising multiple fields with a common owner. An attribute comprising a number of fields to be identified may be used in order to aid in identifying and/or refining tentative boundaries. For example, if a given area is known to comprise 200 fields, method 300 may repeat stages 330 and/or 340 until 200 field boundaries have been identified. This may comprise adjusting criteria for associating data points into individual fields, such as reducing a threshold distance between points to be considered part of the same field, attempting to identify natural barriers between fields, and/or relying on additional data, such as crop types, yield figures, or worker identity. Similarly, data points associated with distortions may be added back in and/or ignored in order to seek out additional divisions that may comprise a field boundary. For example, ignoring data points within 10 meters of a known storage building may increase separation between two clusters of data points, thus providing additional information that may help identify the two clusters as being associated with two different fields.

From stage 340, method 300 may advance to stage 350, where computing device 600 may determine whether a user approves of the identified boundary. For example, the tentative boundary may be displayed to a user, such as on a navigational system, PDA, smartphone, workstation, and/or laptop computer.

If the user does not approve of the tentative boundary, method 300 may advance to stage 355 where computing device 600 may receive a change to the boundary. For example, computing device 600 may identify a single large field based on collected data regarding tilled land from a plurality of tillers. The user may wish to divide the tilled area into two separate fields prior to planting, so the user may add a new line dividing the identified work area as desired. These modifications may be made via any of a number of known user input devices like keyboards, mice, and/or styluses.

After receiving the boundary change at stage 355, or if the user approved the boundary at stage 350, method 300 may advance to stage 360 where computing device 600 may save the boundary. For example, the identified boundary may be saved in the field management system. Consistent with embodiments of the invention, saved boundaries may be used to help identify boundaries of other work areas, such as by requiring that newly identified boundaries not incorporate previously identified work areas.

From stage 360, method 300 may advance to stage 370 where computing device 600 may create a report associated with the identified work area. The report may comprise, for example, an activity report, a fuel usage report, a crop yield report, a consumable usage report, and/or a crop quality report. Computing device 600 may also generate reports across multiple work areas, such as an operator's time worked or efficiency report over several days in multiple different fields.

From stage 370, method 300 may advance to stage 380 where computing device 600 may generate a work plan for the work area. For example, waylines for an operator to follow when working the field and/or a timeline for different tasks to be performed in the field may be created. Method 300 may then end at stage 385.

FIG. 4 is a flow chart of a subroutine 400 for analyzing logged data points. Subroutine 400 may begin at starting block 405 and proceed to stage 410 where computing device 600 may group data points by coordinates. For example, each data point may comprise a latitude/longitude provided by positioning system 110. Computing device 600 may identify adjacent points based on this lat/long data.

Subroutine 400 may then advance to stage 420, where computing device 600 may compare the data points to known geographical and/or topographical features. For example, known roads, rivers, previously identified field boundaries, and/or other known potential borders may be used to generate at least a portion of a work area boundary.

Subroutine 400 may then advance to stage 430, where computing device 600 may group data points by apparatus. For example, several harvesters may be operating across a large area. Data points for each machine may be associated with each other to discover an area worked by that machine. Consistent with embodiments of the invention, machines working in close proximity to each other, such as working alternating rows, may have their data points associated with each other.

Subroutine 400 may then advance to stage 440, where computing device 600 may group data points by an operator identifier. The same operator may use different machines, such as switching from a harvester to a transport truck or switching to a different machine of the same type. The data points from the different machines may thus be associated with each other based on the common operator.

Subroutine 400 may then advance to stage 450, where computing device 600 may group data points by time. For example, all data points collected over a four hour period may be grouped together to identify an area (or areas) worked over that time.

Subroutine 400 may then advance to stage 460, where computing device 600 may categorize a work type associated with each data point. For example, a data point may result from harvesting, tilling, irrigating, spraying, planting, and/or transporting. Each apparatus responsible for generating the data points may be associated with a type of work, or may have several work modes that may be identified as being the active mode at the time the data point is generated.

Subroutine 400 may then advance to stage 470, where computing device 600 may categorize a work state associated with each data point. The apparatus generating the data point may include information such as whether the machine is in a work, idle, or travel state. For example, a harvester may be in a work state while a cutterbar is in active operation, while a travel state may comprise the cutter header being in a lifted and/or locked position while the apparatus is moving. The idle state may comprise the harvester being stationary and/or while the cutterbar is not in active operation.

Subroutine 400 may then advance to stage 480, where computing device 600 may sort by a data measurement. For example, data points may comprise a crop yield measurement. These yields may be used as a sort criterion, and the computer may identify a distinct difference between two groups of data points, thus providing a possible basis for identifying a boundary between two fields comprising different crop varieties.

Once the data points have been grouped, categorized, compared, and/or sorted, the various analyses may be combined to help identify a boundary. For example, data points collected by a particular operator on one day may be associated with a first work area while data points collected by the same operator on another day may be associated with a second work area. If the two work areas share a common boundary, the same work type, and/or a similar crop yield, the two work areas could be combined into a single identified work area. Once these analyses have been completed, subroutine 400 may end at block 485 and return to stage 340 of method 300.

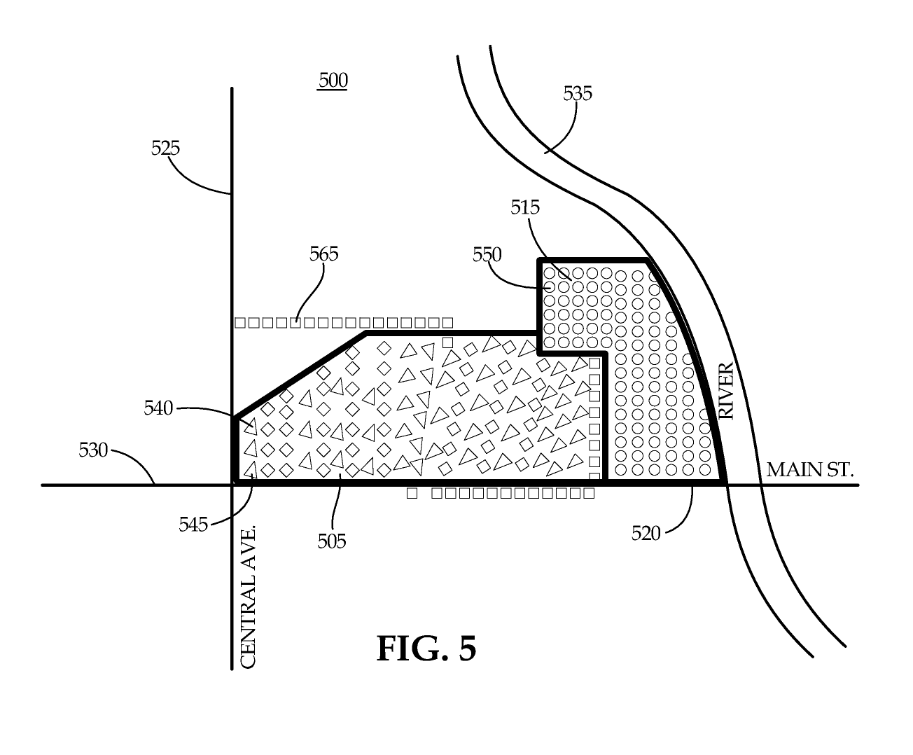

FIG. 5 is a diagram illustrating a plurality of collected data points in a geographical area 500. Geographical area 500 may comprise a first work area 505 surrounded by a first boundary 510 and a second work area 515 surrounded by a second boundary 520. Geographical area 500 may further comprise topographical features such as a first road 525, a second road 530, and a river 535.

First boundary 510 and second boundary 520 may be identified according to methods 300 and 400 described above with respect to FIGS. 3 and 4. For example, first work area 515 may comprise a first plurality of data points 540 collected by a first machine and a second plurality of data points 545 collected by a second machine. Second work area 515 may comprise a third plurality of data points 550. Third plurality of data points 545 may comprise data collected by the first or second machine and/or by a third machine. Geographical area 500 may further comprise a fourth plurality of data points 555 that are associated with a travel state of one and/or more of the machines.

An example of analyzing the data points associated with geographical area 500 may comprise first plurality of data points 540 and second plurality of data points 545 collected by two respective machines performing substantially similar functions on the same day (e.g., two combine harvesters working alternating rows of a field). Fourth plurality of data points 555 may comprise travel data collected by one of the machines on the same day. Computing device 600 may associate all of the data points collected by the machines on the same day. The data points may be further grouped by machine identifier and the type of work performed. As first plurality of data points 540 and second plurality of data points 545 comprise alternating rows in proximity to each other, computing device 600 may identify these pluralities of data points as associated with the same work area. First boundary 510 may thus be identified as surrounding this work area. Consistent with embodiments of the invention, first boundary 510 may be refined using the travel path identified by fourth plurality of data points 555 and/or a known topographical feature like first road 525 and second road 530.

A second example of analyzing the data points may comprise establishing one portion of second boundary 520 based on the identified first boundary 510 of first work area 505 and/or the travel state associated with fourth plurality of data points 555. River 535 and second road 530 may comprise other portions of second boundary 520. The remainder of second boundary 520 may be identified according to the worked area encompassed by third plurality of data points 550.

In some situations, the data points to be analyzed may be associated with distortions such as GPS point drop outs, large field obstacles such as field terraces, drainage area, boulders, and rivers beds, and machine related artifacts such as transportation in and out of the field, fuel depot locations, and maintenance sheds. These distortions may be detected and/or manually plotted in order to improve field identification. For example, data points generated within a threshold distance of a vehicle maintenance bay may be ignored while performing the field detection.

Embodiments consistent with the invention may comprise a system for providing a field boundary. The system may comprise a memory storage and a processing unit coupled to the memory storage. The processing unit may be operative to receive location data points, determine whether each data point is associated with a work area, and identify a boundary of the work area based on the data points. The processor may be further operative to display the boundary to a user, determine whether the user accepts the boundary line, and receive any corrections or updates to the boundary. The processing unit may also be operative to generate a report, work order, or a wayline comprising a guidance path for a machine to follow when operating within the at least one work area.

Other embodiments consistent with the invention may comprise a system for providing a work area boundary. The system may comprise a memory storage and a processing unit coupled to the memory storage. The processing unit may be operative to receive data points, analyze the data points to identify a tentative boundary of a work area, display the tentative boundary to a user, and determine whether the user accepts the tentative boundary. If the user accepts the tentative boundary, the processing unit may be further operative to generate an activity report for the work area. Being operative to analyze the data points may comprise the processing unit being operative to categorize each of the data points as a worked or unworked data point, determine whether a first subset of the data points categorized as worked is bordered by a second subset of the data points categorized as unworked, and, if so, draw the tentative boundary around the first subset of the data points.

Other embodiments consistent with the invention may comprise a system for providing a work area boundary. The system may comprise a memory storage and a processing unit coupled to the memory storage. The processing unit may be operative to receive data points, analyze the data points to identify at least one work area, and generate a report associated with the identified at least one work area. The processing unit may be further operative to update the identified at least one work area according to at least one of the following: a newly received second plurality of data points and a user correction.

FIG. 6 is a block diagram of a system including a computing device 600. As shown in FIG. 6, computing device 600 may include a processing unit 625 and a memory 630. Memory 630 may comprise software modules such as a data point analysis module 635 and a data collection module 640. A field management system 650 may comprise a similar structure and may communicate with computing device 600 over a network 670. While executing on processing unit 625, data point analysis module 635 and data collection module 640 may perform processes for receiving a position, creating a data point and/or a way point, transmitting data to and/or receiving data from field management system 650, and/or collecting sensor data. Computing device 600 may be operative to perform for example, one or more of method 300's stages as described above with respect to FIG. 3 and/or one or more of subroutine 400's stages as described above with respect to FIG. 4. Furthermore, one and/or more of method 300's stages may be performed by field management system 650.

Computing device 600 and/or field management system 650 may be implemented using a personal computer, network computer, mainframe, or other similar microcomputer-based workstation. The processors may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processors may comprise other systems or devices.

Network 670 may comprise, for example, a local area network (LAN) or a wide area network (WAN). Such networking environments are commonplace in work sites, offices, enterprise-wide computer networks, intranets, and the Internet. When a LAN is used as network 670, a network interface located at any of the processors may be used to interconnect any of the processors. The processors may typically include an internal or external modem (not shown) or other means for establishing communications. Further, in utilizing network 670, data sent over network 670 may be encrypted to insure data security by using known encryption/decryption techniques.

A wireless communications system, or a combination of wire line and wireless may be utilized as network 670 in order to, for example, send and receive data points, way points, and/or waylines, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802), a Bluetooth interface, another RF communication interface, and/or an optical interface.

Computing device 600 may also transmit data by methods and processes other than, or in combination with, network 670. These methods and processes may include, but are not limited to, transferring data via, diskette, flash memory sticks, CD ROM, facsimile, conventional mail, an interactive voice response system (IVR), or via voice over a publicly switched telephone network.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing a field boundary, the method comprising:
receiving a plurality of location data points;
determining whether each of the plurality of location data points is associated with at least one work area; and
identifying a boundary line of the at least one work area from at least a subset of the plurality of location data points.

2. The method of claim 1, further comprising:
displaying the identified boundary line to a user; and
determining whether the user accepts the identified boundary line.

3. The method of claim 2, further comprising:
in response to determining that the user accepted the identified boundary line, generating an activity report associated with the at least one work area.

4. The method of claim 3, wherein generating the activity report comprises generating the activity report comprising at least one of the following: a fuel usage report, a crop yield report, a consumable usage report, and a crop quality report.

5. The method of claim 2, further comprising:
in response to determining that the user accepted the identified boundary line, generating at least one wayline within the identified boundary line, wherein the at least one wayline comprises a guidance path for a machine to follow when operating within the at least one work area.

6. The method of claim 2, further comprising, in response to determining that the user did not accept the identified boundary line, receiving at least one manual correction to at least a portion of the identified boundary line.

7. The method of claim 1, wherein receiving the plurality of location data points comprises receiving the plurality of location data points wherein each of the plurality of location data points comprises a location coordinate and at least one of the following: a timestamp, an operator identifier, a machine identifier, a crop yield measurement, a fuel level measurement, a consumable supply level measurement, a travel speed, and a work state.

8. The method of claim 1, wherein receiving the plurality of location data points comprises receiving the plurality of location data points wherein the plurality of location data points comprise a plurality of locations traversed by an apparatus associated with a Global Positioning System component.

9. The method of claim 1, wherein receiving the plurality of location data points comprises receiving the plurality of location data points from a plurality of sources.

10. The method of 1, wherein receiving the plurality of location data points comprises receiving the plurality of location data points from a plurality of sources wherein each of the plurality of sources comprising an apparatus operating within a threshold proximity to each other and within a threshold time period.

11. The method of 1, wherein receiving the plurality of location data points comprises receiving the plurality of location data points from a plurality of sources wherein each of the plurality of sources comprising an apparatus operating within a threshold proximity to each other and within a threshold time period, wherein each of the plurality of sources are performing substantially similar operations.

12. A computer-readable medium which stores a set of instructions which when executed performs a method for providing a work area boundary, the method executed by the set of instructions comprising:
receiving a plurality of data points;
analyzing the plurality of data points to identify a tentative boundary of a work area;
displaying the tentative boundary to a user;
determining whether the user accepts the tentative boundary;
in response to determining that the user has accepted the tentative boundary, generating an activity report for the work area associated with the accepted boundary.

13. The computer-readable medium of claim 12, wherein receiving the plurality of location data points comprises receiving the plurality of location data points from a plurality of machines operating over a predetermined time period.

14. The computer-readable medium of claim 12, wherein receiving the plurality of location data points comprises receiving the plurality of location data points from a plurality of machines operating over a predetermined time period wherein each of the plurality of data points comprise a timestamp, a location coordinate, a machine identifier, and a work state of at least one of the plurality of machines associated with the machine identifier.

15. The computer-readable medium of claim 14, wherein analyzing the plurality of data points to identify the tentative boundary of the work area comprises:
categorizing each of the plurality of data points as a worked or unworked data point according to the work state associated with each of the plurality of data points;
determining whether a first subset of the plurality of data points categorized as worked is bordered by a second subset of the plurality of data points categorized as unworked; and
in response to determining that the first subset of the plurality of data points categorized as worked is bordered by the second subset of the plurality of data points categorized as unworked, drawing the tentative boundary around the first subset of the plurality of data points.

16. The computer-readable medium of claim 12, wherein analyzing the plurality of data points to identify the tentative boundary of the work area comprises:
determining whether at least one of the plurality of data points indicates that a provider of the data point was in a travel state; and
in response to determining that at least one of the plurality of data points indicates that the provider of the data point was in the travel state, removing the at least one data point indicating that the provider was in the travel state from the plurality of data points.

17. The computer-readable medium of claim 12, wherein analyzing the plurality of data points to identify the tentative boundary of the work area comprises:
determining whether a first subset of the plurality of data points are associated with a travel state of a provider of the plurality of data points;
in response to determining that the first subset of the plurality of data points are associated with the travel state of the provider of the plurality of data points, determining whether the first subset of the plurality of data points substantially surrounds a second subset of the plurality of data points, wherein the second subset of the plurality of data points are associated with a work state of the provider of the plurality of data points

18. A system for identifying a work area boundary, the system comprising:
a memory storage; and
a processing unit coupled to the memory storage, wherein the processing unit is operative to:
receive a plurality of data points, wherein each data point comprises a location and wherein the plurality of data points are received from a plurality of machines,
analyze the plurality of data points to identify at least one work area, and
generate a report associated with the identified at least one work area.

19. The system of claim 18, wherein the processing unit being operative to analyze the plurality of data points comprises the processing unit being operative to do at least one of the following: compare the plurality of data points to at least one known topographical feature, group the plurality of data points according to a machine identifier, identify a work state of a machine associated with each of the plurality of data points, and identify a work type performed by the machine associated with each of the plurality of data points.

20. The system of claim 18, wherein the processing unit is further operative to update the identified at least one work area according to at least one of the following: a newly received second plurality of data points and a user correction.
